(19) United States
(12) Patent Application Publication
(10) Pub. No.: US 2014/0264187 A1
(43) Pub. Date: Sep. 18, 2014

(54) Composite Powders For Laser Sintering

(71) Applicants: Carla Lake, Beavercreek, OH (US); Patrick D. Lake, Beavercreek, OH (US)

(72) Inventors: Carla Lake, Beavercreek, OH (US); Patrick D. Lake, Beavercreek, OH (US)

(21) Appl. No.: 14/213,324

(22) Filed: Mar. 14, 2014

Related U.S. Application Data
(60) Provisional application No. 61/787,777, filed on Mar. 15, 2013.

(51) Int. Cl. H01B 1/24; B29C 67/00

(52) U.S. Cl. CPC H01B 1/24; B29C 67/0074
USPC 252/511; 264/401

(57) ABSTRACT

In one aspect, composite powders for laser sintering are described herein. In some embodiments, a composite powder for laser sintering comprises a polymeric matrix and carbon nanofibers disposed in the polymeric matrix. In some embodiments, the polymeric matrix can comprise poly(ether ketone ketone) and the carbon nanofibers can comprise cup-stacked carbon nanotubes.

### CROSS REFERENCE TO RELATED APPLICATION

This application claims priority pursuant to 35 U.S.C. §119 to U.S. Provisional Patent Application Ser. No. 61/787,777, filed on Mar. 15, 2013, which is hereby incorporated by reference in its entirety.

### FIELD

The present invention relates to composite powders and, in particular, to composite powders for use with three-dimensional (3D) printing systems.

### BACKGROUND

The field of rapid prototyping involves the production of prototype articles and small quantities of functional parts directly from computer-generated design data. One method for rapid prototyping includes a selective laser sintering (SLS) process. This method uses layering techniques to build three-dimensional articles. Specifically, this method forms successive thin cross-sections of the desired article. The individual cross-sections are formed by bonding together adjacent grains of a granular or particulate material on a generally planar surface of a bed of the granular material. Each layer is bonded to a previously formed layer at the same time as the grains of each layer are bonded together to form the desired three-dimensional article.

In some cases, printed articles formed by a laser sintering process can exhibit mechanical, physical, and/or electrical properties that are unsuitable for some applications. Therefore, improved granular materials or powders for use in selective laser sintering are desired.

### SUMMARY

In one aspect, composite powders for selective laser sintering are described herein which, in some embodiments, may provide one or more advantages compared to other powders for laser sintering. In some cases, for instance, a composite powder described herein can be used to print an electrically conductive 3D article, including in a more efficient and/or cost effective manner. Further, in some cases, a composite powder described herein can be used to provide a printed 3D article having high thermal stability.

In some embodiments, a composite powder for laser sintering described herein comprises a polymeric matrix and carbon nanoparticles disposed in the polymeric matrix. The polymeric matrix, in some embodiments, comprises or is formed from a polymeric material having a high viscosity and/or a high molecular weight. In some cases, the polymeric matrix comprises or is formed from one or more of poly(ether ether ketone) (PEEK), poly(ether ketone ketone) (PEKK), poly(ether ketone) (PEK), poly(arylether ketone) (PAEK), poly(ether ether ketone ketone) (PEEKK), and poly(ether ketone ether ketone ketone) (PEKEKK).

The carbon nanoparticles of a composite powder described herein, in some instances, can be anisotropic nanoparticles such as carbon nanofibers and/or nanoplatelets. Further, in some embodiments, the carbon nanoparticles have a bimodal size distribution. Moreover, in some embodiments, the carbon nanofibers have a random orientation within the polymeric matrix. Additionally, in some cases, the carbon nanoparticles are present in the powder in an amount of up to about 20 weight percent or in an amount between about 5 weight percent and about 15 weight percent, based on the total weight of the powder.

Further, the carbon nanoparticles of a composite powder described herein can form a network within the polymeric matrix. The network of nanoparticles, in some cases, forms an electronic percolation pathway within the polymeric matrix. Thus, in some embodiments, a composite powder described herein is electrically conductive.

In another aspect, methods of forming a 3D article are described herein. In some embodiments, a method of forming a 3D article comprises providing a layer of granulated particles comprising a composite powder described herein. Moreover, the method, in some embodiments, further comprises exposing at least a portion of the layer of particles to electromagnetic radiation, thereby sintering the particles in the exposed portion. The electromagnetic radiation, in some embodiments, comprises laser light. In addition, in some embodiments, the foregoing steps can be repeated sequentially to make a 3D article in a layer by layer manner.

These and other embodiments are described in greater detail in the detailed description which follows.

### DETAILED DESCRIPTION

Embodiments described herein can be understood more readily by reference to the following detailed description and examples. Elements, apparatus and methods described herein, however, are not limited to the specific embodiments presented in the detailed description and examples. It should be recognized that these embodiments are merely illustrative of the principles of the present invention. Numerous modifications and adaptations will be readily apparent to those of skill in the art without departing from the spirit and scope of the invention.

In addition, all ranges disclosed herein are to be understood to encompass any and all subranges subsumed therein. For example, a stated range of “1.0 to 10.0” should be considered to include any and all subranges beginning with a minimum value of 1.0 or more and ending with a maximum value of 10.0 or less, e.g., 1.0 to 5.3, or 4.7 to 10.0, or 3.6 to 7.9.

All ranges disclosed herein are also to be considered to include the end points of the range, unless expressly stated otherwise. For example, a range of “between 5 and 10” should generally be considered to include the end points 5 and 10.

Further, when the phrase “up to” is used in connection with an amount or quantity, it is to be understood that the amount is at least a detectable amount or quantity. For example, a material present in an amount “up to” a specified amount can be present from a detectable amount and up to and including the specified amount.

### I. COMPOSITE POWDERS

In one aspect, composite powders for laser sintering are described herein. In some embodiments, a composite powder described herein comprises a polymeric matrix and carbon nanoparticles disposed or dispersed in the polymeric matrix.

Turning now to specific components of composite powders, composite powders described herein comprise a polymeric matrix. The polymeric matrix can comprise or be formed from any polymer or polymeric material not inconsistent with the objectives of the present invention. In some cases, the polymeric matrix comprises or is formed from a polymer or polymeric material having a high viscosity and/or a high molecular weight. Such a polymer or polymeric material, in some embodiments, can have a weight average molecular weight of at least about 80,000 g/mol or at least about 90,000 g/mol. In some instances, a polymer or polymeric material of a polymeric matrix described herein can have a weight average molecular weight between about 60,000 g/mol and about 130,000 g/mol, between about 70,000 g/mol and about 120,000 g/mol, or between about 80,000 g/mol and about 100,000 g/mol. Further, in some embodiments, the polymeric matrix comprises or is formed from a polymer or polymeric material having a melt viscosity of at least about 500 Poise (P), at least about 1000 P, at least about 2000 P, or at least about 3000 P when measured according to ASTM D3835 at 750° F. and a shear rate of 1000/s, before combination with a filler such as carbon nanoparticles described herein. In some cases, a polymer or polymeric material of a polymeric matrix described herein can have a melt viscosity between about 800 P and about 4000 P, between about 1000 P and about 4000 P, or between about 1000 P and about 3000 P, when measured according to ASTM D3835 at 750° F. and a shear rate of 1000/s, before combination with a filler. Polymers and polymeric materials having other molecular weights and/or viscosities can also be used. Moreover, in some cases, a polymeric matrix can be formed from a polymer or polymeric material having both a molecular weight described hereinabove and a viscosity described hereinabove.

In some embodiments, a polymeric matrix comprises or is formed from a poly(ether ether ketone) (PEEK), poly(ether ketone ketone) (PEKK), poly(ether ketone) (PEK), poly(arylether ketone) (PAEK), poly(ether ether ketone ketone) (PEEKK), poly(ether ketone ether ketone ketone) (PEKEKK), or a blend or combination of one or more of the foregoing. For instance, in some cases, a polymeric matrix comprises or is formed from PEKK.

Composite powders described herein also comprise carbon nanoparticles. Any carbon nanoparticles not inconsistent with the objectives of the present invention may be used. In some cases, for example, the carbon nanoparticles comprise, consist, or consist essentially of anisotropic nanoparticles such as carbon nanofibers. Carbon nanofibers, in some embodiments, include carbon nanotubes, including single-wall carbon nanotubes (SWCNTs) or multi-wall carbon nanotubes (MWCNTs). In other cases, carbon nanofibers comprise herringbone carbon nanotubes or stacked-cup carbon nanotubes.

Carbon nanofibers of a composite powder described herein can have any dimensions not inconsistent with the objectives of the present invention. In some embodiments, for instance, the carbon nanofibers have an average diameter between about 50 nm and about 150 nm. In addition, in some cases, the carbon nanofibers have an average length between about 5 μm and about 500 μm, between about 5 μm and about 100 μm, between about 5 μm and about 50 μm, between about 50 μm and about 500 μm, or between about 100 μm and about 500 μm. Moreover, in some embodiments, carbon nanofibers described herein have an aspect ratio of greater than about 100, greater than about 1000, or greater than about 5000, where the aspect ratio can be based on the length of a nanofiber divided by the width or diameter of the nanofiber. In other instances, carbon nanofibers have an aspect ratio of less than about 1000, less than about 500, or less than about 100. In some cases, carbon nanofibers described herein have an aspect ratio between about 25 and about 10,000, between about 25 and about 1000, between about 50 and about 5000, between about 100 and about 1000, between about 1000 and about 10,000, between about 1000 and about 5000, or between about 5000 and about 10,000.

Carbon nanoparticles of a composite powder described herein can also comprise, consist, or consist essentially of carbon nanoplatelets. Any carbon nanoplatelets not inconsistent with the objectives of the present invention may be used. In some embodiments, for instance, carbon nanoplatelets comprise graphene platelets. “Graphene” platelets, for reference purposes herein, include sp²-bonded carbon as a primary carbon component, as opposed to spa-bonded carbon. In some instances, a graphene platelet described herein comprises no sp³-hybridized carbon or substantially no sp³-hybridized carbon. For example, in some embodiments, a graphene platelet comprises less than about 10 atom percent or less than about 5 atom percent sp³-hybridized carbon, relative to the total amount of carbon in the platelet.

Moreover, a “nanoplatelet,” for reference purposes herein, can refer to an anisotropic nanoparticle having a flat or plate-like structure, wherein the thickness of the structure is less than the length and width of the structure. The carbon nanoplatelets of a composite powder described herein can have any dimensions not inconsistent with the objectives of the present invention. In some embodiments, for instance, the nanoplatelets have an average thickness of less than about 1000 nm, less than about 500 nm, or less than about 100 nm. In some cases, the nanoplatelets have an average thickness between about 1 nm and about 1000 nm, between about 1 nm and about 500 nm, between about 10 nm and about 1000 nm, or between about 10 nm and about 500 nm. Further, in addition to a thickness described above, the carbon nanoplatelets can also have an average length and/or an average width of less than about 10 μm, less than about 5 μm, or less than about 1 μm. In some cases, the carbon nanoplatelets have an average length and/or an average width between about 100 nm and about 10 μm, between about 100 nm and about 5 μm, between about 100 nm and about 1 μm, between about 500 nm and about 10 μm, or between about 1 μm and about 10 μm. Moreover, in some embodiments, carbon nanoplatelets described herein have an aspect ratio of greater than about 10, greater than about 50, greater than about 100, or greater than about 1000, where the aspect ratio can be based on the length or width of a nanoplatelet divided by the thickness of the nanoplatelet. In other instances, carbon nanoplatelets described herein have an aspect ratio of less than about 1000, less than about 100, or less than about 50. In some cases, carbon nanoplatelets described herein have an aspect ratio between about 10 and about 10,000, between about 10 and about 5000, between about 10 and about 1000, between about 10 and about 100, between about 10 and about 50, between about 50 and about 1000, or between about 100 and about 1000.

Carbon nanoparticles of a composite powder described herein can also comprise, consist, or consist essentially of high structured carbon black. A “high structured” carbon black, for reference purposes herein, comprises a carbon black having a compressed oil absorption number (COAN) of at least about 110 m²/g, at least about 120 m²/g, or at least about 130 m²/g, when measured according to ASTM D3493. Additionally, in some cases, carbon nanoparticles comprising high structured carbon black are anisotropic carbon nanoparticles having an aspect ratio greater than about 2, greater than about 5, or greater than about 10.

The carbon nanoparticles of a composite powder described herein can also comprise a combination or mixture of carbon nanofibers, carbon nanoplatelets, and/or high structured carbon black described herein. Any combination or mixture not inconsistent with the objectives of the present invention may be used. Further, other electrically conductive carbonaceous particulate materials may also be used in conjunction with or in place of the carbon nanoparticles described herein.

Additionally, in some embodiments, the carbon nanoparticles of a composite powder described herein have a bimodal size distribution. In some embodiments, the bimodal size distribution is a bimodal distribution of lengths or widths of the carbon nanoparticles. In other cases, the bimodal size distribution is a bimodal distribution of aspect ratios of the carbon nanoparticles, such as anisotropic carbon nanoparticles. For instance, in some embodiments, a bimodal population of anisotropic carbon nanoparticles can comprise first carbon nanoparticles having a first average aspect ratio and second carbon nanoparticles having a second average aspect ratio differing from the first average aspect ratio, such that the aspect ratio distribution of the bimodal population exhibits two “peaks” corresponding to the first average aspect ratio and the second average aspect ratio. Further, the first carbon nanoparticles can have a first size distribution that does not substantially overlap with a second size distribution of the second carbon nanoparticles. Size distributions that do not “substantially” overlap one another, for reference purposes herein, can overlap by less than about 20 percent, less than about 15 percent, or less than about 10 percent, based on the total area of the first and second size distributions.

In one non-limiting example, carbon nanofibers having a bimodal size distribution comprise a population of long nanofibers and a population of short nanofibers, where the terms “long” and “short” are relative to one another. For example, in some embodiments, the average length of the population of long nanofibers of a bimodal distribution can be up to about 100 times the average length of the population of short nanofibers of the distribution. In some embodiments, the average length of the population of long nanofibers is between about 2 times and about 20 times or between about 2 times and about 10 times the average length of the population of short nanofibers. Moreover, if desired, the short nanofibers can also have a smaller average diameter than the long nanofibers.

In another non-limiting example, carbon nanofibers having a bimodal distribution of aspect ratios comprise a population of high aspect ratio nanofibers and a population of low aspect ratio nanofibers, where the terms “high” and “low” are relative to one another. For example, in some embodiments, the average aspect ratio of the population of high aspect ratio nanofibers of a bimodal distribution can be up to about 100 times or up to about 10 times the average aspect ratio of the population of low aspect ratio nanofibers of the distribution. In some embodiments, the average aspect ratio of the population of high aspect ratio nanofibers is between about 2 times and about 20 times or between about 2 times and about 10 times the average aspect ratio of the population of low aspect ratio nanofibers.

In embodiments comprising a bimodal distribution of nanoparticles such as nanofibers, the two subpopulations of nanoparticles can be present in any relative amount not inconsistent with the objectives of the present invention. For example, in some embodiments, the weight ratio of short nanofibers to long nanofibers is between about 8:1 and about 1:8. In some embodiments, the weight ratio is between about 5:1 and about 1:5. Such weight ratios can also be used for other biomodal distributions of other carbon nanoparticles described herein, such as a bimodal distribution of carbon nanoplatelets having a relatively high aspect ratio and carbon nanoplatelets having a relatively low aspect ratio.

Carbon nanoparticles can be present in a composite powder described herein in any amount not inconsistent with the objectives of the present invention. In some embodiments, for instance, the carbon nanoparticles are present in the powder in an amount of up to about 25 weight percent or up to about 20 weight percent, based on the total weight of the powder. In some embodiments, the carbon nanoparticles are present in the powder in an amount between about 7 weight percent and about 20 weight percent, between about 10 weight percent and about 25 weight percent, between about 10 weight percent and about 20 weight percent, or between about 5 weight percent and about 15 weight percent. Other amounts are also possible.

Moreover, the carbon nanoparticles of a composite powder described herein can be disposed or dispersed in the polymeric matrix in any manner not inconsistent with the objectives of the present invention. In some embodiments, for example, anisotropic carbon nanoparticles such as carbon nanofibers have a random orientation within the polymeric matrix, meaning the long axes of the carbon nanofibers extend in random directions within the polymeric matrix. Similarly, carbon nanoplatelets can also have a random orientation within a polymeric matrix, meaning the short axes (corresponding to the thickness of the nanoplatelets) extend in random directions within the polymeric matrix. Thus, a population of carbon nanoparticles having a random orientation in a polymeric matrix can provide a composite powder having an isotropic or substantially isotropic microstructure rather than an anisotropic microstructure.

Further, in some cases, the carbon nanoparticles of a composite powder described herein form a network within the polymeric matrix. A “network,” for reference purposes herein, can comprise a plurality of carbon nanoparticles in physical and/or electrical contact with one another. The network of nanoparticles, in some cases, forms an electronic percolation pathway within the polymeric matrix.

In addition, a composite powder described herein can exhibit one or more desired mechanical, physical, thermal, and/or electrical properties. For example, in some embodiments, a composite powder described herein is electrically conductive, rather than electrically insulating. A composite powder, in some cases, exhibits a volume resistivity between about 1×10⁸ and about 10×10¹⁰ Ohm cm, when measured according to ASTM D257. Further, a composite powder described herein, in some instances, can exhibit a surface resistivity between about 10×10⁸ and about 10×10⁹ Ohm/sq, when measured according to ASTM D257. In some embodiments, a composite powder described herein is semiconducting or exhibits semiconductor behavior. In addition, in some cases, an article formed from a composite powder described herein exhibits a tensile strength between about 11 ksi and about 14 ksi, when measured according to ASTM D638, including in a “green” or uncured or un-infiltrated state. In some embodiments, an article formed from a composite powder described herein exhibits a tensile strength between about 14 ksi and about 16 ksi or between about 15 ksi and about 17 ksi, including in a green state, when measured according to D638.

A composite powder described herein can also have any physical dimensions not inconsistent with the objectives of the present invention. In some embodiments, for instance, a powder has an average particle size of less than about 100 μm. In some embodiments, a powder has an average particle size between about 30 μm and about 70 μm. Alternatively, in other embodiments, a powder has an average particle size greater than about 100 μm. Further, in some embodiments, a composite powder described herein has a narrow size distribution. For example, in some embodiments, the standard deviation of a composite powder size distribution is about 15 percent or less.

In some embodiments, the size distribution is about 10 percent or less or about 5 percent or less.

It is further to be understood that composite powders described herein can exhibit any combination of components and/or properties described herein not inconsistent with the objectives of the present invention. For example, in some cases, a composite powder (1) comprises a polymeric matrix having any melt viscosity described herein (such as a melt viscosity of at least about 500 P, when measured as described herein), (2) comprises any carbon nanoparticles described herein (such as carbon nanofibers having a bimodal distribution of aspect ratios) in any amount described herein (such as an amount up to about 20 weight percent, based on the total weight of the powder) and in any orientation described herein (such as a random orientation within the polymeric matrix), and also (3) exhibits any average particle size described herein (such as an average composite powder particle size of less than about 100 μm). Such a composite powder may also be electrically conductive. Other combinations of components and/or properties are also possible.

A composite powder described herein can be made in any manner not inconsistent with the objectives of the present invention. For example, in some embodiments, a composite powder described herein is formed by comminuting, grinding, milling, or pulverizing composite particles. The composite particles, in some embodiments, comprise carbon nanoparticles described herein disposed or dispersed in a polymeric matrix described herein. Further, such composite particles can be formed by mixing, combining, or blending the carbon nanoparticles with the polymer or polymeric material of the polymeric matrix. Such mixing, combining, or blending can be carried out in any manner not inconsistent with the objectives of the present invention. For example, in some embodiments, composite particles are formed according to a method described in U.S. Pat. No. 8,048,341 to Burton et al.

### II. METHODS OF FORMING A 3D ARTICLE

In another aspect, methods of forming a 3D article are described herein. In particular, methods of forming a 3D article using a selective laser sintering (SLS) process are described herein. As understood by one of ordinary skill in the art, such an SLS process can be carried out in any manner and using any machine or apparatus not inconsistent with the objectives of the present invention. In some embodiments, for instance, an SLS process can be carried out in a manner described in U.S. Pat. No. 5,733,497 to McAlea et al.

Thus, in some embodiments, a method of forming a 3D article comprises providing a layer of granulated particles comprising a composite powder described herein. The composite powder can comprise any powder described in Section I hereinabove. For example, in some cases, the composite powder comprises a network of carbon nanofibers having a bimodal size distribution dispersed in a polymeric matrix comprising one or more of poly(ether ether ketone) (PEEK), poly(ether ketone ketone) (PEKK), poly(ether ketone) (PEK), poly(arylether ketone) (PAEK), poly(ether ether ketone ketone) (PEEKK), and poly(ether ketone ether ketone ketone) (PEKEKK). Other composite powders described herein may also be used.

In addition, a method described herein, in some embodiments, further comprises exposing at least a portion of the layer of granulated particles to electromagnetic radiation, thereby sintering the particles in the exposed portion. In some embodiments, the electromagnetic radiation comprises laser light. Any wavelength and/or power of laser light not inconsistent with the objectives of the present invention may be used. In some cases, for instance, carbon dioxide laser light having an average wavelength of about 10.6 μm is used. Further, in some embodiments, the laser light used for sintering particles described herein has a power between about 5 Watts (W) and about 50 W.

Such a laser sintering process, in some embodiments, can be repeated in a layer by layer or stepwise fashion to provide a 3D article, as understood by one of ordinary skill in the art. Thus, in some embodiments, a method described herein further comprises providing one or more additional layers of granulated particles comprising a powder described herein and exposing at least a portion of each additional layer to electromagnetic radiation to sinter the particles of the exposed portions. Further, in some embodiments, the granulated particles of one or more layers are exposed to electromagnetic radiation according to preselected computer aided design (CAD) parameters. In this manner, a method described herein can be used to provide a 3D article having a desired size and/or shape.

All patent documents referred to herein are incorporated by reference in their entireties. Various embodiments of the invention have been described in fulfillment of the various objectives of the invention. It should be recognized that these embodiments are merely illustrative of the principles of the present invention. Numerous modifications and adaptations thereof will be readily apparent to those skilled in the art without departing from the spirit and scope of the invention.

That which is claimed:

1. A composite powder for laser sintering, the powder comprising:
a polymeric matrix; and
carbon nanofibers dispersed in the polymeric matrix, wherein the carbon nanofibers have a bimodal size distribution.

2. The powder of claim 1, wherein the carbon nanofibers comprise a population of long nanofibers and a population of short nanofibers, wherein the average length of the population of long nanofibers is between about 2 times and about 20 times the average length of the population of the short nanofibers.

3. The powder of claim 2, wherein the weight ratio of short nanofibers to long nanofibers is between about 8:1 and about 1:8.

4. The powder of claim 1, wherein the polymeric matrix comprises one or more of poly(ether ether ketone) (PEEK), poly(ether ketone ketone) (PEKK), poly(ether ketone) (PEK), poly(arylether ketone) (PAEK), poly(ether ether ketone ketone) (PEEKK), and poly(ether ketone ether ketone ketone) (PEKEKK).

5. The powder of claim 4, wherein the polymeric matrix comprises PEKK.

6. The powder of claim 1, wherein the carbon nanofibers are present in the powder in an amount of up to about 20 weight percent, based on the total weight of the powder.

7. The powder of claim 1, wherein the carbon nanofibers are present in the powder in an amount between about 5 weight percent and about 15 weight percent.

8. The powder of claim 1, wherein the carbon nanofibers comprise cup-stacked carbon nanotubes.

9. The powder of claim 1, wherein the carbon nanofibers comprise single-wall carbon nanotubes or multi-wall carbon nanotubes.

10. The powder of claim 1, wherein the carbon nanofibers have a random orientation within the polymeric matrix.

11. The powder of claim 1, wherein the powder has an average particle size of less than about 100 μm.

12. The powder of claim 1, wherein the powder is electrically conductive.

13. A method of forming a 3D article comprising:
providing a layer of granulated particles comprising a composite powder;
exposing at least a portion of the layer of particles to electromagnetic radiation, thereby sintering the particles in the exposed portion, wherein the composite powder comprises a polymeric matrix and carbon nanofibers dispersed in the polymeric matrix, the carbon nanofibers having a bimodal size distribution.

14. The method of claim 13, wherein the polymeric matrix comprises one or more of poly(ether ether ketone) (PEEK), poly(ether ketone ketone) (PEKK), poly(ether ketone) (PEK), poly(arylether ketone) (PAEK), poly(ether ether ketone ketone) (PEEKK), and poly(ether ketone ether ketone ketone) (PEKEKK).

15. The method of claim 14, wherein the carbon nanofibers are present in the powder in an amount of up to about 20 weight percent, based on the total weight of the powder.

16. The method of claim 13, wherein the carbon nanofibers have a random orientation within the polymeric matrix.

17. The method of claim 13, wherein the carbon nanofibers comprise a population of long nanofibers and a population of short nanofibers, wherein the average length of the population of long nanofibers is between about 2 times and about 20 times the average length of the population of the short nanofibers.

18. The method of claim 17, wherein the weight ratio of short nanofibers to long nanofibers is between about 8:1 and about 1:8.

19. The method of claim 13, wherein the electromagnetic radiation comprises laser light.

20. The method of claim 13 further comprising providing one or more additional layers of granulated particles comprising the composite powder and exposing at least a portion of each additional layer to electromagnetic radiation to sinter the particles of the exposed portions, wherein the method is carried out in a layer by layer manner to provide the 3D article.
